(19) United States
(12) Patent Application Publication
(10) Pub. No.: US 2002/0159212 A1
(43) Pub. Date: Oct. 31, 2002

(54) Voltage protection apparatus and methods using switched clamp circuits

(76) Inventor: George W. Oughton JR., Raleigh, NC (US)

Correspondence Address: MYERS BIGEL SIBLEY & SAJOVEC, PO BOX 37428, RALEIGH, NC, 27627, US

(21) Appl. No.: 10/106,972

(22) Filed: Mar. 25, 2002

Related U.S. Application Data
(60) Provisional application No. 60/286,733, filed on Apr. 25, 2001.

(51) Int. Cl. H02H 3/22

(52) U.S. Cl. 361/111; 361/119

(57) ABSTRACT

A circuit protection apparatus includes first and second terminals configured to be coupled to respective first and second circuit nodes of a circuit. A switching circuit is operative to intermittently couple a clamp circuit, for example, a metal oxide varistor (MOV) or a silicon avalanche suppressor (SAS), between the first and second terminals. The switching circuit may be operative to intermittently couple the clamp circuit between the first and second terminals responsive to a voltage at at least one of the first and second terminals. The switching circuit may include a switch that is operative to couple and decouple the clamp circuit between the first and second terminals responsive to a control input applied thereto. A control circuit may be operative to generate the control input responsive to a voltage at at least one of the first and second terminals. The switch may include an AC-commutated switch, for example, a thyristor such as a triac, and the control circuit may include a trigger circuit that generates a trigger signal for the AC-commutated switch responsive to a voltage at at least one of the first and second terminals. In other embodiments, the switch includes a transistor, such as a MOSFET that is controlled by a control circuit responsive to a voltage at at least one of the first and second terminals. Related methods are also discussed.

### RELATED APPLICATION

This application claims the benefit of provisional application No. 60/286,733, filed Apr. 25, 2001, the disclosure of which is hereby incorporated herein by reference.

### BACKGROUND OF THE INVENTION

The present invention relates to electrical protection apparatus and methods, and more particularly, to voltage protection apparatus and methods.

Communications systems that are distributed over large geographic areas, such as cable television (CATV) networks, are typically subject to a variety of voltage disturbances that can damage network components or degrade their performance. For example, a typical CATV power distribution system may include a plurality of pole-mounted signal repeaters that receive power from an extended network including several coaxial conductor segments. These units may be subject to voltage surges and other phenomena caused by load changes (e.g., short circuits) and other network operations, as well as to high-energy voltage transients induced by, for example, lightning strikes.

A number of different techniques are conventionally used to reduce damage and degradation caused by voltage fluctuations in such networks. For example, overvoltage protection for a device, such as a CATV signal repeater may be provided by connecting a suppression device such as a metal oxide varistor (MOV) or silicon avalanche suppressor (SAS), in a shunt fashion across the input terminals of the device. CATV systems may also use “crowbar” surge suppressor circuits that impose a short circuit across a line when the line voltage on the line exceeds a predetermined value.

Each of these voltage protection techniques may have disadvantages. For example, a shunt MOV may not offer effective clamping action until voltage on the line is significantly higher than nominal. The short circuiting action of a crowbar circuit may cause significant disruption in a CATV power distribution system, as release of the short circuit may induce transient responses in the power regulators (e.g., ferroresonant transformer regulators) that control the line voltage, causing voltage fluctuations that can last for several cycles of the AC power waveform.

### SUMMARY OF THE INVENTION

According to some embodiments of the invention, a circuit protection apparatus includes first and second terminals configured to be coupled to respective first and second circuit nodes of a circuit. A switching circuit is operative to intermittently couple a clamp circuit, for example, a metal oxide varistor (MOV) or a silicon avalanche suppressor (SAS), between the first and second terminals. The switching circuit may be operative to intermittently couple the clamp circuit between the first and second terminals responsive to a voltage at at least one of the first and second terminals.

In some embodiments of the invention, the switching circuit includes a switch operative to couple and decouple the clamp circuit between the first and second terminals responsive to a control input applied thereto. A control circuit is operative to generate the control input responsive to a voltage at at least one of the first and second terminals. The switch may include an AC-commutated switch, for example, a thyristor such as a triac, that couples the clamp circuit between the first and second terminals responsive to a trigger signal and that decouples the clamp circuit from between the first and second terminals responsive to a voltage across the switch. The control circuit may include a trigger circuit, coupled to at least one of the first and second terminals, that generates the trigger signal responsive to a voltage at at least one of the first and second terminals.

In other embodiments of the invention, the switch includes a transistor, such as a MOSFET or IGBT, that is operative to couple and decouple the clamp circuit between the first and second terminals responsive to a control signal applied thereto. The control circuit generates the control signal responsive to a voltage at at least one of the first and second terminals.

In some embodiments of the invention, an apparatus for protecting a line from overvoltage includes a first terminal configured to be coupled to the line and a second terminal configured to be coupled to a circuit node, e.g., a ground. A switching circuit is coupled to an MOV and to the first and second terminals and operative to intermittently couple the MOV between the first and second terminals. The MOV may be selected such that, if a nominal voltage of the line were to be continuously applied across the MOV for a sufficiently long time, a power rating of the MOV would be exceeded.

According to method embodiments of the present invention, a line may be protected from voltage transients by coupling a clamp circuit between the line and a circuit node, e.g., another line or a ground, responsive to a voltage on the line increasing above a first predetermined threshold, and then decoupling the clamp circuit from between the line and the circuit node responsive to the voltage on the line falling below a second predetermined threshold. The clamp circuit may include, for example, an MOV or an SAS.

Embodiments of the invention can provide several advantages over conventional surge suppression apparatus and methods. For example, surge suppression circuits according to embodiments of the invention may effectively clamp at lower voltage levels than conventional MOV suppressors, with reduced wearout phenomena. Surge suppressor circuits according to embodiments of the invention may also produce less power supply disruption than crowbar-type suppressor circuits.

### BRIEF DESCRIPTION OF THE DRAWINGS

FIG. 1 is a schematic diagram illustrating a circuit protection apparatus according to embodiments of the invention.

FIG. 2 is a schematic diagram illustrating a circuit protection apparatus according to other embodiments of the invention.

FIG. 3 is a schematic diagram illustrating an AC circuit protection apparatus according to some embodiments of the invention.

FIG. 4 is a waveform diagram that graphically illustrates exemplary operations of a circuit protection apparatus according to embodiments of the invention illustrated in FIG. 3 in comparison to operations of conventional suppressor circuits.

FIG. 5 is a schematic diagram illustrating a DC circuit protection apparatus according to some embodiments of the invention.

### DETAILED DESCRIPTION

The present invention now will be described more fully hereinafter with reference to the accompanying drawings, in which embodiments of the invention are shown. This invention may, however, be embodied in many different forms and should not be construed as limited to these embodiments; rather, these embodiments are provided so that this disclosure will be thorough and complete, and will fully convey the scope of the invention to those skilled in the art. In the drawings, like numbers refer to like elements.

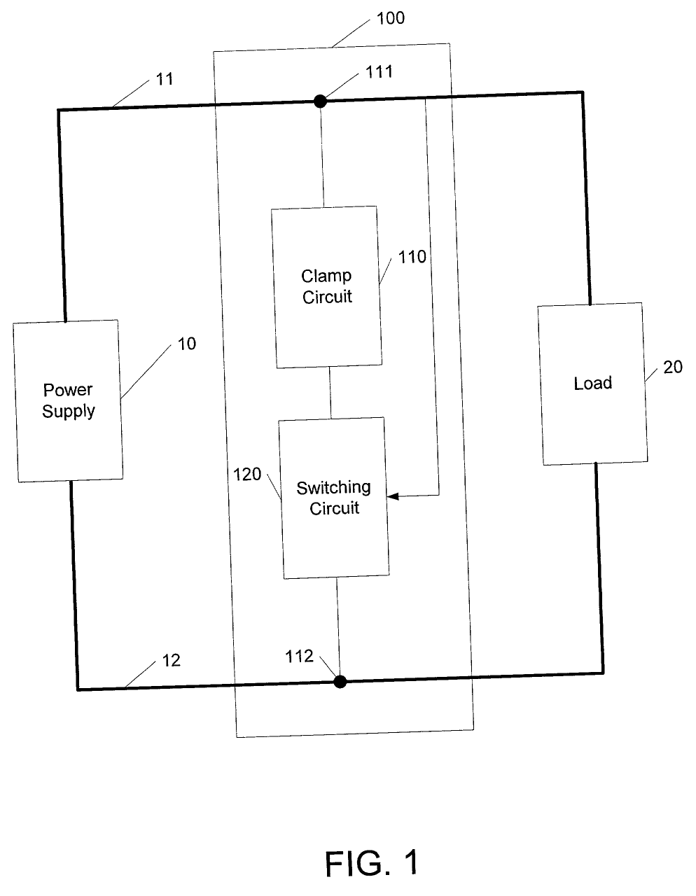

FIG. 1 illustrates a circuit protection apparatus 100 according to some embodiments of the invention. The circuit protection apparatus 100 is operative to protect an electrical circuit, here shown as a load 20 that is supplied power by a power supply 10 via power lines 11, 12. The circuit protection apparatus 100 is connected to the lines 11, 12 at respective first and second terminals 111, 112, and includes a clamp circuit 110 and a switching circuit 120 that is operative to intermittently couple the clamp circuit 110 between the first and second terminals 111, 112 responsive to a voltage on the line 11. It will be appreciated that the first and second lines 11, 12 may comprise a variety of different conductors. For example, the first line 11 may be a phase conductor of an AC utility, while the second line 12 may be, for example, a ground (e.g., an earth ground or ground conductor) or another phase conductor of the AC utility.

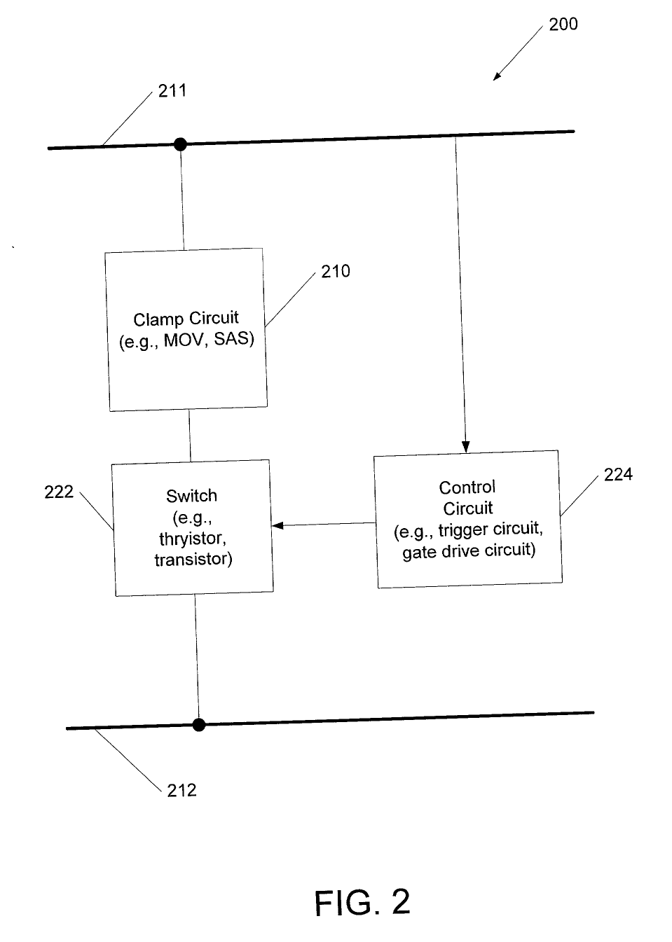

According to embodiments of the invention illustrated in FIG. 2, a circuit protection apparatus 200 for providing overvoltage protection for lines 211, 212 includes a clamp circuit 210, such as a metal oxide varistor (MOV) or a silicon avalanche suppressor (SAS). The clamp circuit 210 is coupled and decoupled from between the lines 211, 212 by a switch 222, for example, an AC commutated switch (e.g., a thyristor) or a transistor (e.g., a MOSFET or IGBT), responsive to a control signal generated by a control circuit 224. The control circuit 224 generates the control signal responsive to a voltage on the line 211.

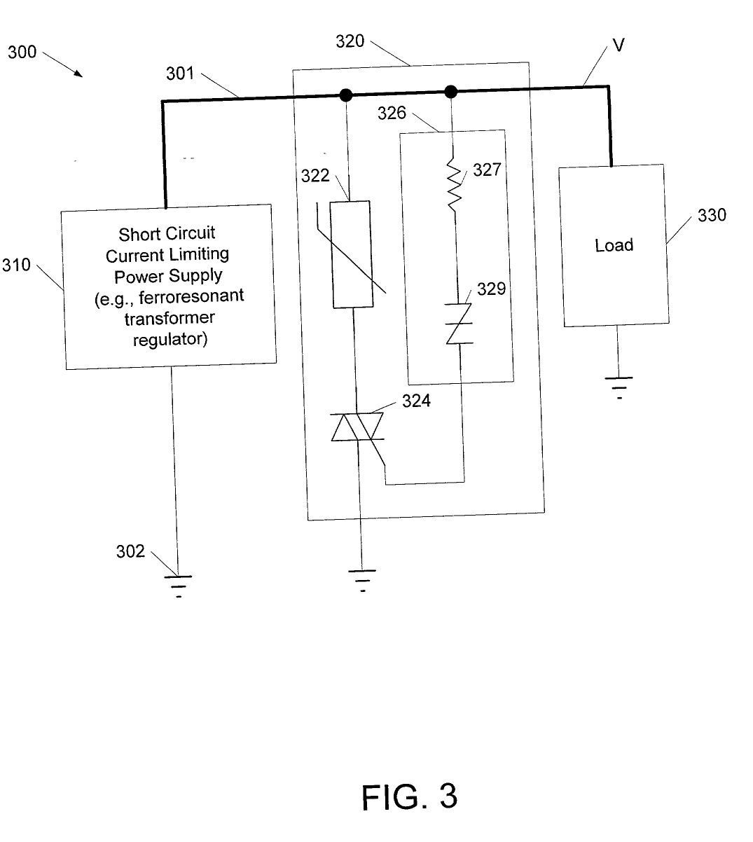

FIG. 3 illustrates a circuit configuration according to embodiments of the invention that may be advantageously used in a distributed power network such as a CATV power network 300. The network 300 may include a short circuit current limiting power supply 310, such as a power supply that employs a ferroresonant transformer regulator. The power supply 310 maintains a voltage V at a load 330, for example, a signal repeater, via a power line 301. A circuit protection apparatus 320 includes an MOV 322 that is intermittently coupled between the power line 301 and a ground 302 responsive to the voltage V between the power line 301 and the ground 302. In particular, an AC-commutated switch, here a bidirectional current conducting triac thyristor 324, couples and decouples the MOV 322 from the ground 302 responsive to a trigger signal generated by a trigger circuit 326. As illustrated, the trigger circuit 326 includes a series combination of a resistor 327 and a diac thyristor 329.

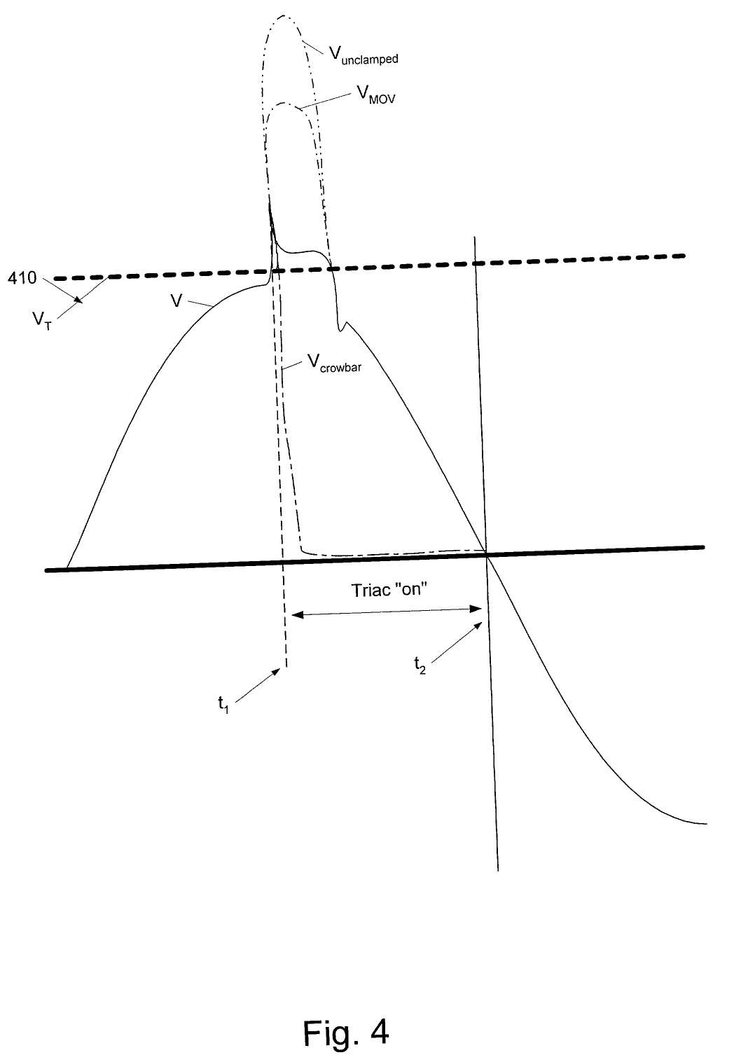

Exemplary operations of the circuit protection apparatus 320 are illustrated in FIG. 4. When the voltage V is less than a threshold voltage V_{T} of the trigger circuit diac 329, the MOV 322 is decoupled from between the power line 301 and the ground 302, thus providing a high impedance therebetween. However, when the voltage V increases above the threshold voltage V_{T} at a time t₁, as in the case, for example, of a voltage surge or spike, the trigger circuit 326 triggers the triac switch 324, causing the MOV 322 to be coupled between the power line 301 and the ground 302. This clamps the voltage V at a lower level than a voltage V_{unclamped} that the line 301 might experience if unclamped. Assuming, as shown in FIG. 4, that the voltage surge is resolved before the end of a half-cycle 410 of the voltage V, the triac 324 remains on for the remainder of the half-cycle 410 and commutates off at time t₂ when the voltage V crosses through zero volts.

In embodiments of the invention, the use of an intermittently connected surge suppressor, such as the MOV 322 of FIG. 3, can provide a protection apparatus that may have more desirable characteristics than conventional suppression apparatus such as shunt MOV circuits or crowbar suppressor circuits. A potential drawback of many conventional shunt MOV circuits is that the MOV is typically selected to have a continuous power rating that will not normally be exceeded when the power line to which it is connected is operating at nominal voltage. Due to the current vs. voltage characteristics of MOVs, selecting the MOV to meet this continuous power constraint typically means that the MOV may not effectively clamp until voltage on the line is significantly higher than the nominal voltage, to the point that equipment failure and/or damage may occur. This is conceptually illustrated in FIG. 4 as a voltage V_{MOV t}hat might be experienced by the line 301 if a conventional MOV suppressor circuit were connected between the line 301 and the ground 302.

According to embodiments of the invention illustrated in FIG. 3, the MOV 322 may be selected to have a relatively lower effective clamping voltage and a continuous power rating that would be violated if the MOV 322 were coupled between the power line 301 and the ground 302 for a sufficiently long time with the voltage on the line 301 at a nominal level, for example, if the MOV 322 were continuously coupled between the power line 301 and the ground 302. As can be seen from FIG. 4, for many short-term transient voltage surges or spikes, the MOV 322 connected as in FIG. 3 will conduct current for a relatively short period of time before the triac 324 again decouples it from between the power line 301 and the ground 302. Accordingly, power dissipation in and heating of the MOV 322 can be limited.

In other words, using the MOV 322 in series with a switching element such as the triac 324 allows the MOV 322 to have a lower “voltage rating” than the nominal voltage of the power line 301. For example, an MOV selected for conventional shunt application with a power line that operates at a nominal 90 V rms would typically have a 90 V (or higher) rating. Such a device may allow voltage on the line to increase 50% or more above the nominal 90 V level, which could allow equipment to be damaged from overvoltage. According to embodiments of the invention, an MOV that is intermittently connected responsive to line voltage can have a lower voltage rating, for example, 60 V. Such a device will generally clamp more effectively at lower voltages than the 90 V rated MOV, and thus may provide increased overvoltage protection.

Another potential advantage of the invention is that it may reduce the “wearout” phenomenon often exhibited by conventionally configured MOVs. As will be appreciated by those skilled in the art, “wearout” in an MOV refers to an increase in leakage current in the MOV near its rated voltage that occurs as a result of the MOV being subjected to voltage above the MOV's energy withstand rating. Wearout in an MOV is generally cumulative, and often leads to increased steady state loss when the MOV is operated near its rated voltage. Eventually, the increased loss may lead to overheating and failure. According to aspects of the invention as described above, for example, with reference to FIGS. 3 and 4, such steady state losses may be substantially reduced, as the MOV is generally operates only when actively coupled between the power line and ground during voltage transients.

The invention may also be advantageous over conventional crowbar surge suppressor circuits. For example, as conceptually illustrated in FIG. 4, if a conventional crowbar suppressor circuit were connected between the line 301 and the ground 302, the voltage V_{crowbar} produced between the line 301 and the ground 302 after triggering by the surge at time t₁ could hold the line 301 in a short-circuited condition until the end of the half-cycle 410. This could effectively remove power from devices connected to the line 301 for an undesirable length of time and may cause other undesirable effects, including disturbances to regulator circuits powering the line 301 that result in voltage fluctuations over multiple cycles.

It will be understood that circuit configurations other than the circuit configuration of FIG. 3 are within the scope of the present invention. For example, the MOV 322 may be replaced with another type of clamp circuit, such as a silicon avalanche suppressor (SAS). The triac 324 may be replaced with any of a number of different circuits that perform similar functions, including, for example, other types of thyristor circuits, such as circuits employing back-to-back connected silicon controlled rectifiers (SCRs). Similarly, the diac 329 may be replaced by circuits with similar functionality, for example, circuits including other types of devices, such as circuits including sidacs or bidirectional (e.g., back-to-back coupled) zener diodes. It will also be appreciated that components of the protection apparatus 320 may be rearranged to provide similar functionality.

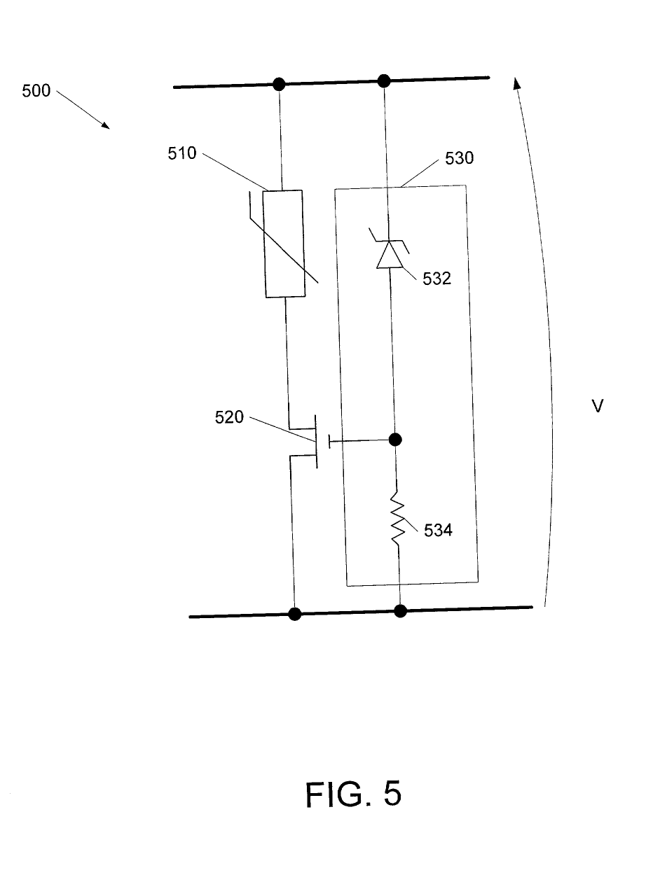

It will be appreciated that the circuit configuration illustrated in FIG. 3 may be particularly advantageous for use in AC applications. FIG. 5 illustrates a protection apparatus 500 according to other embodiments of the invention that may be used for DC applications. The protection apparatus 500 includes a clamp circuit, here an MOV 510, that is intermittently coupled between circuit nodes 501, 502 by a switch, here shown as a MOSFET transistor 520. The transistor 520 is controlled by a control signal generated by a control circuit 530 including a zener diode 532 and a resistor 534.

Exemplary operations of the protection apparatus 500 are as follows. When a voltage V on the circuit node 501 with respect to the circuit node 502 is less than a threshold voltage of the zener diode 532, the transistor 520 is “off” and decouples the MOV 510 from circuit node 502. When the voltage V exceeds a threshold voltage of the zener diode 532, however, the zener diode 532 begins to conduct, causing the voltage applied to the gate of the transistor 520 to increase, turning the transistor 520 “on” and coupling the MOV 510 between the circuit nodes 501, 502.

It will be appreciated that circuit configurations other than that illustrated in FIG. 5 fall within the scope of the invention. For example, it will be appreciated that the gate drive circuit configuration illustrated in FIG. 5 may result in operating the transistor 520 in a linear fashion, such that significant power dissipation and voltage drop may occur in the transistor 520. Such linear operation may be reduced by using a control circuit, e.g., a bistable circuit, which quickly drives the transistor 520 into saturation when the voltage between the circuit nodes 501, 502 exceeds a desired level. A non-linear power switching device, such as gate turn on device (e.g., a GTO), may be used in place of the transistor 520.

In the drawings and specification, there have been disclosed typical embodiments of the invention and, although specific terms are employed, they are used in a generic and descriptive sense only and not for purposes of limitation, the scope of the invention being set forth in the following claims.

That which is claimed:

1. A circuit protection apparatus, comprising:
first and second terminals configured to be coupled to respective first and second circuit nodes of a circuit;
a clamp circuit; and
a switching circuit operative to intermittently couple the clamp circuit between the first and second terminals.

2. An apparatus according to claim 1, wherein the switching circuit is operative to intermittently couple the clamp circuit between the first and second terminals responsive to a voltage at at least one of the first and second terminals.

3. An apparatus according to claim 2, wherein the switching circuit comprises:
a switch operative to couple and decouple the clamp circuit between the first and second terminals responsive to a control input applied thereto; and
a control circuit operative to generate the control input responsive to a voltage at at least one of the first and second terminals.

4. An apparatus according to claim 3:
wherein the switch comprises an AC-commutated switch operative to couple the clamp circuit between the first and second terminals responsive to a trigger signal and to decouple the clamp circuit from between the first and second terminals responsive to a voltage across the switch; and
wherein the control circuit comprises a trigger circuit, coupled to at least one of the first and second terminals, that generates the trigger signal responsive to a voltage at at least one of the first and second terminals.

5. An apparatus according to claim 4, wherein the AC-commutated switch comprises a thyristor.

6. An apparatus according to claim 5, wherein the thyristor comprises a triac.

7. An apparatus according to claim 5, wherein the thyristor comprises a first thyristor, and wherein the trigger circuit comprises a second thyristor.

8. An apparatus according to claim 7, wherein the second thyristor comprises a diac.

9. An apparatus according to claim 3:
wherein the switch comprises a transistor operative to couple and decouple the clamp circuit between the first and second terminals responsive to a control signal applied thereto; and
wherein the control circuit generates the control signal responsive to a voltage at at least one of the first and second terminals.

10. An apparatus according to claim 9:
wherein the transistor comprises a MOSFET operative to couple and decouple the clamp circuit between the first and second terminals responsive to a gate drive signal; and
wherein the control circuit generates the gate drive signal responsive to a voltage at least one of the first and second terminals.

11. An apparatus according to claim 1, wherein the clamp circuit comprises at least one of a metal oxide varistor (MOV) and a silicon avalanche suppressor (SAS).

12. An apparatus for protecting a line from overvoltage, the apparatus comprising:
a first terminal configured to be coupled to the line;
a second terminal configured to be coupled to a circuit node;
a metal oxide varistor (MOV); and
a switching circuit coupled to the MOV and to the first and second terminals and operative to intermittently couple the MOV between the first and second terminals.

13. An apparatus according to claim 12, wherein the circuit node comprises a ground.

14. An apparatus according to claim 12, wherein the line operates at a nominal voltage that, if continuously applied across the MOV for a sufficiently long time, would cause a power rating of the MOV to be exceeded.

15. An apparatus according to claim 12, wherein the switching circuit is operative to intermittently couple the MOV between the first and second terminals responsive to a voltage at the first terminal.

16. An apparatus according to claim 15, wherein the switching circuit comprises:
an AC-commutated switch operative to couple the MOV between the first and second terminals responsive to a trigger signal and to decouple the MOV from between the first and second terminals responsive to a voltage at the first terminal; and
a trigger circuit operative to generate the trigger signal responsive to a voltage at the first terminal.

17. An apparatus according to claim 16, wherein the AC-commutated switch comprises a thyristor having a trigger terminal that receives the trigger signal.

18. An apparatus according to claim 17, wherein the thyristor comprises a triac.

19. An apparatus according to claim 17, wherein the thyristor comprises a first thyristor, and wherein the trigger circuit comprises a second thyristor coupled to a trigger terminal of the first thyristor.

20. An apparatus according to claim 19, wherein the second thyristor comprises one of a diac and a sidac coupled between the first terminal and the trigger terminal of the first thyristor.

21. An apparatus according to claim 12, wherein the switching circuit comprises:
a switch operative to couple and decouple the MOV between the first and second terminals responsive to a control signal; and
a control circuit that generates the control signal responsive to a voltage at the first terminal.

22. An apparatus according to claim 21, wherein the switch comprises a transistor.

23. A method of protecting a line from voltage transients, the method comprising:
coupling a clamp circuit between the line and a circuit node responsive to a voltage on the line increasing above a first predetermined threshold; and then
decoupling the clamp circuit from between the line and the circuit node responsive to the voltage on the line falling below a second predetermined threshold.

24. A method according to claim 23, wherein the circuit node comprises a ground.

25. A method according to claim 23, wherein the clamp circuit comprises at least one of a metal oxide varistor (MOV) and a silicon avalanche suppressor (SAS).

26. A method according to claim 23, wherein the step of decoupling comprises the step of decoupling the clamp circuit from between the line and the circuit node responsive to a zero-crossing of the voltage on the line.

27. A method according to claim 23, wherein the clamp circuit comprises an MOV, and wherein the step of coupling is preceded by regulating the voltage on the line to a nominal voltage that, if continuously applied across the MOV for a sufficiently long time, would cause a power rating of the MOV to be exceeded.
